(19) United States
(12) Patent Application Publication
(10) Pub. No.: US 2011/0107623 A1
(43) Pub. Date: May 12, 2011

(54) CLEARING BLADE

(76) Inventor: Hartmut Neidlein, Weinstadt (DE)

(21) Appl. No.: 12/737,139

(22) PCT Filed: Jun. 6, 2009
(86) PCT No.: PCT/DE2009/000792

§ 371 Date: Dec. 10, 2010

(30) Foreign Application Priority Data
Jun. 10, 2008 (DE) 10 2008 027 549.2

(51) Int. Cl. A01G 23/06

(52) U.S. Cl. 37/302

(57) ABSTRACT

The invention relates to a device and a method for removal of root stumps with an excavator, the welding adapter of which has a hook (2,3), that tapers on one side to a sharp edge (4) over the length of said hook. The hook is used for slicing the material of the root stump.

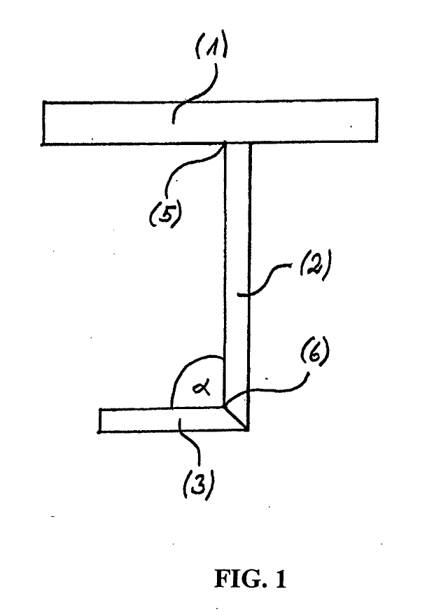

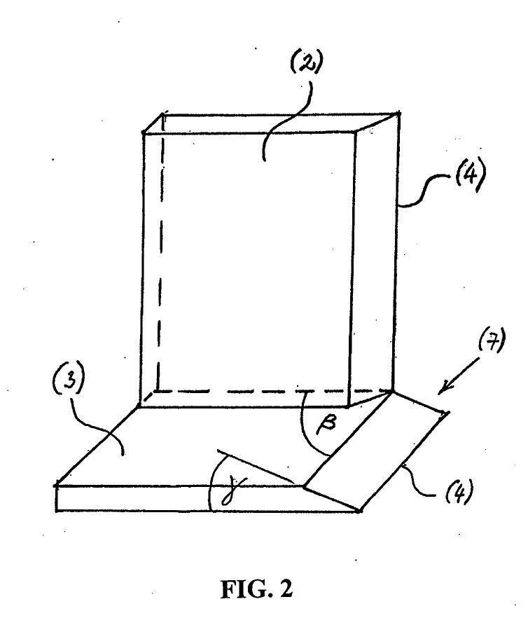

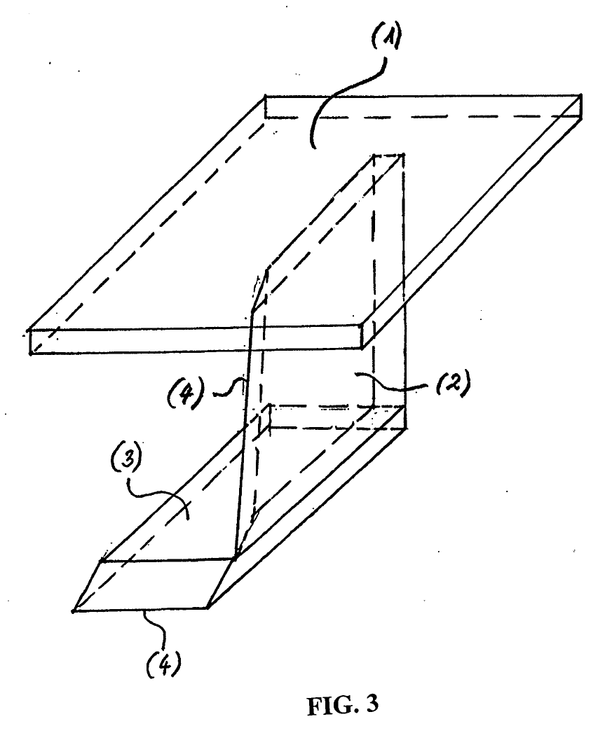

If trees are removed then stump and roots—and in the following designated as: root stump—have to be removed, in particular in park gardens and in inner city regions. On the one hand this enables the planing and the reforestation of the surface. Then in the cases in which a tree is again to be planted at the same location. roots, which remain in the planting region, biologically unfavorable influence the growth of the new trees.

According to the state of the art, root stumps are milled away. For this purpose, root milling cutters are employed, which are associated with a series of disadvantages: the milling depth is limited by the radius of the milling drums. The dug out material is a mixture of earth and wood splinters. Root milling cutters are expensive.

It is an object of the invention to furnish an economic device and method for eliminating and removing of even deeply extending root stumps in such manner as wood parts can be cleared substantially unmixed with ground material. This object is obtained as follows:

Welding adapters are usual, commercial accessories for excavators. They are plates which are furnished on their upper side with an attachment device for the arm of the excavator. Usual are “Quick changers” having a horizontal bolt which surrounds and then arrests the arm of the excavator from above with hook, and for example snaps in. Such adapters can also be immediately to the arm of the excavator with a cross bolt. Arbitrary devices can be welded to the bottom side of the plate, wherein the arbitrary devices are then moved together with the excavator.

A hook is at the bottom side of the welding plate (1) according to the present invention, wherein the hook is narrowed at least on one side cross to the hook plane that a sharp edge—in the following: knife edge (4)—is generated. (Claim 1)

Such a hook can be produced from plates. A plate is with one of its edges such attached at the bottom side of the welding plate, that the plate projects downwardly from the welding plate—in the following: stab plate (2). A further plate is attached at the edge (6) of the stab plate and disposed relatively remote from the welding plate in such a way that its face stands perpendicular to the face of this stab plate—in the following designated as: pit plate (3). At least in each case one of the two other edges of stab plate and the pit plate is narrowed to the knife edge (4), wherein the narrowing advantageously is reached by having one of the limiting planes of the plates unchanged and the other one is inclined towards the knife edge.

Therewith root stumps can be removed with an excavator in such manner that the wood of the stump with the approximately vertically running fibers is split or, respectively, is scraped with the stab plate and at the same time the root parts close to the stem, also about along their fibers, are scraped or, respectively, are split by the pit plate. (Claim 2)

The stab plate (2) is advantageously disposed on the welding plate (1) such that the face of this stab plate (2) is disposed in the plane, in which plane the excavator arm moves. This has the consequence that the knife edge (4) points in this direction. This arrangement is also then preferred, where the hook does not consist of step plate and welding plate, but is performed in a different manner. (Claim 3)

Advantageous is also a set angle in the order of magnitude of 5 degrees, which alleviates the penetration of the stab plate into the stem part of the root stump. It is advantageous to give a set angle to the knife edge of the stab plate, similar to the knife in a plane. This angle, by which the plane, on which the arm of the excavator performs its motions, is inclined relative to one of the two planes which form the knife edge, however may not be larger than 5 degrees. This set angle alleviates further the penetration of the stab plate into the stem part of the root stump. If the angle is larger, then penetration would not be alleviated but rendered more difficult. (Claim 4)

The stab plate stands advantageously vertically on the welding plate and the pit plate stands vertically on the stab plate. (Claim 5)

An exact right angle is however not a precondition for the usefulness of the apparatus. A right angle between stab plate and welding plate is particularly advantageous. An angle between stab plate and welding plate, wherein the angle at most about 10 degrees deviates from a right angle in such a way that the stab plate and the pit plate are coordinated to each other in the kind of an open hook. This arrangement improves the function capability of the apparatus for the following application: if a root stump is already substantially worked out and the roots are cut off at the edge of the intended scraping pit, then the excavator can be driven under the root stump substantially disengaged from the ground material and the root stump can overall be dug out with the “hook”, formed by the stab plate and pit plate. (Claim 6)

It is purposeful with this arrangement that the center of gravity of the pit plate then, when the face of the pit plate plane is planar, is disposed vertically under the center of gravity of the complete apparatus. The secure stand of the complete apparatus is enabled on the pit plate thereby, which in turn allows an uncomplicated gripping and snapping together of the attachment elements of the welding plate with the arm of the excavator. (Claim 7)

If only in each case one edge of stab plate and pit plate is formed as a knife edge, then it is advantageous that this knife edge points to the excavator. This creates the possibility that the arm of the excavator can be removed as is the case with a scoop excavator: the arm starts the work cycle with a stretched position, moves downwardly along a circle and continues its motion back to the excavator, wherein the knife edge splits or, respectively, cuts the material of the root stump. (Claim 8)

The coordination of pit plate to the stab plate is particularly advantageous in the way that the knife edge of the pit plate projects beyond the knife edge of the stab plate. (7) This arrangement effects that the two edges impact the root stump not as a uniform edge with the consequence that the excavator then immediately has to overcome a large resistance. Instead the knife edge of the pit plate digs first into the root stump and then the knife edge of the stab plate. (Claim 9)

It is furthermore particularly advantageous wherein the angle (β) between the knife edge of the pit plate and the plane of the stab plate deviates from a right angle. This has the consequence that then, when the apparatus is moved in the plane of the stab plate towards the root stump, the knife edge of the pit plate when it hits the root stump, then not immediately over its complete length about simultaneously impacts on the root stump, but inclined with the consequence of a drawing cut, which transforms particularly advantageously the force of the excavator. (Claim 10)

Two requirements have to be observed for optimizing the knife edge, wherein the requirements lead to opposite structures. The more acute the angle (γ) between the two planes, which form the knife edge, is, the better the knife edge cuts and the more sensitive the knife edge is against damages. The more obtuse the angle (γ) is, the worse the knife edge cuts and the more resistant the knife edge is as far as damages are concerned. It is proposed according to the present invention that the angle (γ) is not more acute than 25 degrees and is not more obtuse than 35 degrees.

This achieves at the same time a good dimensioning of the “nose” (7), which nose forms the knife edge of the pit plate there where the pit plate encounters the knife edge of the stab plate, if the embodiment proposed according to claims 9, 10 is selected. Since there the forces of the excavator act point-shaped onto the material of the root stump, very high pressures are generated there, which introduce very well the thereupon following splitting or, respectively, the peeling or, respectively, scraping. (Claim 11)

If the hook is formed with the stab plate and with the welding plate, then it shall be dimensioned such large on the one hand that an efficient working becomes possible. On the other hand not too large for the than same reasons. The following dimensioning is proposed: A length between 20 cm and 40 cm is proposed for the knife edge of the stab plate. A length between 5 cm and 15 cm is proposed for the knife edge of the pit plate. The edge formed by the stab plate and the pit plate advantageously has a length between 20 cm and 30 cm. (Claim 12)

If the hook according to the present invention is performed with stab plate and welding plate, then usually in the way that the plates are welded together. The high forces, which occur, load the welding seams to such an extent that they can rip apart. In accordance with the present invention it is proposed that the positions are reinforced. Either by reinforcing the welding seams themselves. Alternatively, metal bars, for example angle strips are welded in. There is always the result that the welding plate and the pit plate are thicker there as compared to the remaining region of the plates. (Claim 13)

Advantageously, steel with the properties of Hardox 500 is proposed as a material for the stab plate and for the pit plate. (Claim 14)

The connection between the welding plate and the stab plate on the one hand, stab plate and pit plate on the other hand can be produced such that the plates abut each other bluntly and the welding seams are placed in the angles, which the plates form with each other. Grooves in the welding plate on the one hand and grooves in the pit plate on the other hand are proposed as a more stable connection, into which the edges of the stab plate (2) can be inserted prior to the welding. This connection contributes much to the stability such that the welding seams have to be less expensive. (Claim 15)

It is claimed in claim 10 that the angle, which the knife edge of the pit plate forms relative to the plane of the stab plate, is smaller than 90 degrees. It is proposed as a further improvement that the direction of the knife edge in the region of the stab plate stands relative to the stab plate at an angle of 90 degrees, then however bends with the consequence that the angle is smaller than 90 degrees in the further course. This embodiment takes the circumstance into consideration that based on the asymmetrical coordination of the pit plate relative to the stab plate, the resistance forces of the tree stump, which act on the knife edge, effect a torque. This torque is the larger, the further the resistance force is remote from the stab plate. If the knife edge is bevelled to the rear, then this leads there to a decrease of the resistance forces and thus to a decrease of the torque. (Claim 16)

1. Welding adapter with clearing knife for excavators with an attachment device for the arm of the excavator at the upper side of the welding plate (1) characterized in that the clearing knife is formed as a hook, wherein the hook consists of a part (2) projecting from the lower side of the welding plate (1) downwardly and the part (3) running cross to the part (2) and which hook is narrowed at least on one side over its complete length or over part of the length perpendicular to the hook plane to form a sharp knife edge (4).

2. Welding adapter according to claim 1, characterized in that the hook is formed from two plates (2,3) of which one stab plate (2) is attached with an edge at the bottom side of the welding plate (1) and a pit plate (3) attached at the bottom edge of the stab plate (2) and cross to the stab plate (2), wherein in each case at least one edge of stab plate and pit plate on the same side are narrowed, completely or in part, to the knife edge (4).

3. Welding adapter according to claim 2, characterized in that the stab plate (2) is disposed perpendicular on the welding plate (1), and the pit plate (3) is disposed perpendicular on the stab plate (2).

4. Welding adapter according to claim 2, characterized in that the angle (α) between stab plate (2) and pit plate (3) is smaller than 90 degrees and larger than 80 degrees.

5. Welding adapter according to claim 2, characterized in that the knife edge (4) of the pit plate (3) projects (7) over the knife edge (4) of the stab plate.

6. Welding adapter according to claim 2, characterized in that the knife edge (4) of the pit plate (3) and that the line, on which the pit plate (3) and the stab plate (2) abut to each other, are arms of an angle (β), which angle (β) is smaller than 90 degrees.

7. Welding adapter according to claim 2 characterized in that the angle (γ) between the two faces, which delimit the knife edge (4), is larger than 25 degrees and is smaller than 35 degrees.

8. Welding adapter according to claim 2, characterized in that the knife edge (4) of the stab plate has a length between 20 cm and 40 cm and/or the knife edge (4) of the pit plate (3) has a length between 5 cm and 15 cm, or the edge, which the stab plate (2) and the pit plate (3) form, has a length between 20 cm and 30 cm.

9. Welding adapter according to claim 2, characterized in that in each case at least one inner edge (6) between the stab plate (2) and the pit plate (3) or an inner edge (5) between the stab plate (2) and the welding plate (1) is reinforced in such a way that there the respective material strength is larger than in the remaining region of the force plates.

10. Welding adapter according to claim 2 characterized in that the hook is made of a steel with a Brinell hardness HBW=500.

11. Welding adapter according to claim 1, characterized in that the
edges of the stab plate (2) are installed in grooves of the welding plate (1) on the one hand, and in grooves of the pit plate (3) on the other hand.

12. Welding adapter according to claim 1, characterized in that the knife edge (4) of the pit plate (3) is angled off in a such way that the knife edge (4) runs from the stab plate (2) initially at an angle of 90 degrees and then forks such that its angle to the stab plate (2) becomes smaller than 90 degrees.

13. Method for the clearing of root stumps with the device according to claim 1, characterized in that the clearing knife formed as a hook is repeatedly led along at stump and roots such that the clearing knife separates or splits in layers the material of stump and roots.
